(19) United States
(12) Patent Application Publication
(10) Pub. No.: US 2023/0158735 A1
(43) Pub. Date: May 25, 2023

(54) Methods of Making Additive Manufactured Articles Using Multilayer Articles, Objects Prepared by the Methods, and Multilayer Articles

(71) Applicant: 3M INNOVATIVE PROPERTIES COMPANY, St. Paul, MN (US)

(72) Inventors: Gareth A. Hughes, St. Paul, MN (US); Jeffrey N. Bartow, St. Paul, MN (US); Steven J. Ilkka, Stillwater, MN (US)

(21) Appl. No.: 17/910,506

(22) PCT Filed: Apr. 13, 2021
(86) PCT No.: PCT/IB2021/053047

§ 371 Date: Sep. 9, 2022

Related U.S. Application Data
(60) Provisional application No. 63/016,390, filed on Apr. 28, 2020.

(51) Int. Cl. B29C 64/124; B29C 64/40; B33Y 10/00; B33Y 80/00; B32B 5/02; B32B 7/12; B32B 27/08; B32B 27/12; B32B 27/32

(52) U.S. Cl. CPC B29C 64/124; B29C 64/40; B33Y 10/00; B33Y 80/00; B32B 5/022; B32B 7/12; B32B 27/08; B32B 27/12; B32B 27/32; B32B 2250/02; B32B 2038/0076

(57) ABSTRACT

The present disclosure provides a method of making an additive manufactured article. The method includes: a) attaching a multilayer structure (300, 500) to a build platform (210); b) selectively curing a photocurable composition (219) that is in contact with a porous layer (330, 530) of the multilayer structure, thereby forming an object attached to the porous layer; and c) separating the object from the build platform. The multilayer structure includes an adhesive layer (310, 510), an impermeable layer (320, 520) attached to the adhesive layer, and a porous layer (330, 530) attached to the impermeable layer. The adhesive layer of the multilayer structure is attached to the build platform. The present disclosure also provides an object made by the method, and the multilayer article used in the method. Use of the multilayer article assists in improving adhesion between the build platform and the object.

### SUMMARY

In a first aspect, a method of making an additive manufactured article is provided. The method includes a) attaching a multilayer structure to a build platform; b) selectively curing a photocurable composition that is in contact with the porous layer of the multilayer structure, thereby forming an object attached to the porous layer; and c) separating the object from the build platform. The multilayer structure comprises an adhesive layer, an impermeable layer attached to the adhesive layer, and a porous layer attached to the impermeable layer. The adhesive layer of the multilayer structure is attached to the build platform.

In a second aspect, an object is provided. The object is prepared by the method according to the first aspect.

In a third aspect, a multilayer article is provided. The multilayer article includes a) an adhesive layer; b) an impermeable layer attached to the adhesive layer; and c) a porous layer attached to the impermeable layer. The porous layer includes either i) a plurality of fibers, or ii) a foam, and comprises a plurality of pores having an average diameter of 1 micrometer to 1.5 millimeters.

Use of the multilayer article in methods according to at least certain embodiments of the present disclosure improves adhesion of a photocured composition to a build platform, e.g., when using an inverse vat polymerization printer.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF DRAWINGS

FIG. 1 is a generalized process flow diagram of a method of making an additive manufactured article according to the present disclosure.

FIG. 2 is a generalized schematic of a stereolithography apparatus configured for a bottom-up approach.

FIG. 3 is a schematic cross-sectional view of a multilayer article according to the present disclosure.

FIG. 4 is a schematic cross-sectional view of an adhesive having a multilayer construction for use in a multilayer article according to the present disclosure.

FIG. 5 is a schematic cross-sectional view of another exemplary multilayer article according to the present disclosure.

FIG. 6 is a block diagram of a generalized system 600 for additive manufacturing of an article.

FIG. 7 is a block diagram of a generalized manufacturing process for an article.

FIG. 8 is a high-level flow chart of an exemplary article manufacturing process.

FIG. 9 is a high-level flow chart of an exemplary article additive manufacturing process.

FIG. 10 is a photograph of two exemplary additive manufactured articles, prepared according to the present disclosure.

FIG. 11 is a photograph of the results of the use of the nonwoven material of Comparative Example 1.

FIG. 12 is a photograph of the results of the use of the nonwoven material of Example 3.

FIG. 13A is a photograph of the foam material of Comparative Example 5 showing that no articles were successfully adhered to the surface of the foam.

FIG. 13B is a photograph of the cured articles of Comparative Example 5 adhered to the bottom of the resin container.

FIG. 14 is a photograph of the results of the use of the foam material of Example 6.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but rather include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

As used herein, “continuous” with respect to additive manufacturing processes describes a process whereby photocurable liquid flows across the surface of a gradient of cured material and is polymerized by patterned light without the formation of a discrete layer, and means that the manufacturing may not be constantly continuous and can encompass brief pauses that may occur due to changing the irradiation pattern (e.g., related to frame rate of switching a sequence of projected two-dimensional images) on a photocurable composition, due to small step-wise movement of a build plate through the material, or both. Stated another way, continuous additive manufacturing processes according to the present disclosure form a gelled article at a rate of 0.5 millimeters per minute (mm/min) or greater in a build axis, 0.6 mm/min, 0.7 mm/min, 0.8 mm/min, 0.9 mm/min, or 1.0 mm/min or greater in a build axis, with discrete steps of smaller than 5 micrometers, smaller than 4 micrometers, smaller than 3 micrometers, smaller than 2 micrometers, or smaller than 1 micrometer. In contrast, conventional layer by layer additive manufacturing is typically a cyclic process whereby photocurable liquid flows across the surface and is polymerized by patterned light into a uniform gel layer prior to the application of additional liquid across the polymerized gel layer. The gel strength of the half layer furthest from the light source is within 20% of the gel strength of the half layer nearest the light, and the process forms a gelled article at a rate of 0.25 mm/min or less in a build axis or 0.20 mm/min or less in a build axis.

As used herein, “impermeable” with respect to a substrate means that a fluid (e.g., water, organic solvent, etc.) does not pass from one major surface of the substrate through the opposing major surface of the substrate under conditions of additive manufacturing, namely when contacted with the fluid for up to 1 hour under a pressure of 30 psi (200 kilopascals) or less. It is not necessary for the substrate to also minimize passing of a fluid under other conditions to be “impermeable”.

As used herein, “acrylic adhesive” means an acrylic ester type pressure sensitive adhesive.

As used herein, “hot melt adhesive” means an adhesive such as polyolefin block copolymers (SBS, SIS), ethylene-vinyl acetate copolymer (EVA) or the like, which is a solid at room temperature and can achieve adhesion in several minutes of pressing and cooling after being melt into a liquid by heating and coated on an article to be adhered.

As used herein, “structural adhesive” means an adhesive of epoxy resin, polyurethane or the like, which has high strength, relatively large loading endurance, aging resistance, fatigue resistance, corrosion resistance, stable performance in predetermined life, and are applicable to the adhesion of the structures for bearing strong force.

As used herein, “foam” and “foaming material” each mean a material such as polyethylene, polyurethane, acrylic acid or the like which has compressibility after foaming.

As used herein, “(co)polymer” means a relatively high molecular weight material having a molecular weight of at least about 10,000 g/mole (in some embodiments, in a range from 10,000 g/mole to 5,000,000 g/mole). The term “(co)polymer” includes homopolymers and copolymers, as well as homopolymers or copolymers that may be formed in a miscible blend, e.g., by co-extrusion or by reaction, including, e.g., transesterification. “(Co)polymer” also includes random, block and star (e.g., dendritic) (co)polymers.

As used herein, “nonwoven fibrous web” or “nonwoven web” mean a collection of fibers characterized by entanglement or point bonding of the fibers to form a sheet or mat exhibiting a structure of individual fibers or filaments which are interlaid, but not in an identifiable manner as in a knitted fabric.

As used herein, the term “hardenable” refers to a material that can be cured or solidified, e.g., by heating to remove solvent, heating to cause polymerization, chemical crosslinking, radiation-induced polymerization or crosslinking, or the like.

As used herein, “curing” means the hardening or partial hardening of a composition by any mechanism, e.g., by heat, light, radiation, e-beam, microwave, chemical reaction, or combinations thereof.

As used herein, “cured” refers to a material or composition that has been hardened or partially hardened (e.g., polymerized or crosslinked) by curing.

As used herein, “photocured” refers to a material or composition that has been hardened or partially hardened using actinic radiation.

As used herein, “closed cell foam” means that the foam contains substantially no connected cell pathways that extend from one outer surface through the material to another outer surface. A closed cell foam can include up to about 10% open cells, within the meaning of “substantially” no connected cell pathways. As used herein, “open cell foam” means that the majority of the cells (voids) are interconnected rather than being isolated as in a closed-cell foam. An open celled foam can include up to about 10% closed cells.

As used herein, “discontinuous”, with respect to a fiber or collection of fibers, means fibers having a finite aspect ratio (e.g., a ratio of length to diameter of e.g., less than about 10,000).

The term “mass inertial force” as referred to herein may be specified as force per unit mass and therefore may be specified in the unit m/s². Further, the mass inertial force can be expressed by the G-force which is a factor of the acceleration of gravity. For the purposes of the present specification the acceleration of gravity is 9.81 m/s². Consequently, for example a mass inertial force of 9.81 m/s² can be expressed as 1 G.

As used herein, “particle” refers to a substance being a solid having a shape which can be geometrically determined. The shape can be regular or irregular. Particles can typically be analyzed with respect to, e.g., particle size and particle size distribution. A particle can comprise one or more crystallites. Thus, a particle can comprise one or more crystal phases.

As used herein, “polymerizable composition” means a hardenable composition that can undergo polymerization upon initiation (e.g., free-radical polymerization initiation, ring opening polymerization, etc.). Typically, prior to polymerization (e.g., hardening), the polymerizable composition has a viscosity profile consistent with the requirements and parameters of one or more 3D printing systems. In some embodiments, for instance, hardening comprises irradiating with actinic radiation having sufficient energy to initiate a polymerization or cross-linking reaction. For instance, in some embodiments, ultraviolet (UV) radiation, e-beam radiation, or both, can be used. When actinic radiation can be used, the polymerizable composition is referred to as a “photocurable composition”. As used herein, “photocurable composition liquid dispersion” refers to a photocurable composition that has a continuous liquid phase and discontinuous solids (e.g., abrasive particles) dispersed in the continuous liquid phase. Polymerizable components of the photocurable composition are in a continuous liquid phase.

As used herein, a “resin” contains all polymerizable components (monomers, oligomers and/or polymers) being present in a hardenable composition. The resin may contain only one polymerizable component compound or a mixture of different polymerizable compounds.

As used herein, “solvent” refers to a nonreactive liquid component of a composition that dissolves at least one solid component, or dilutes at least one liquid component, of the composition (in the case of water, adventitious amounts of water are not included by the term “solvent”).

As used herein, “solid” refers to a state of matter that is solid at one atmosphere of pressure and at least one temperature in the range of from 20-25° C., inclusive, (as opposed to being in a gaseous or liquid state of matter).

As used herein, “thermoplastic” refers to a polymer that flows when heated sufficiently above its glass transition point and become solid when cooled.

As used herein, “thermoset” refers to a polymer that permanently sets upon curing and does not flow upon subsequent heating. Thermoset polymers are typically crosslinked polymers.

Stereolithography (or vat polymerization) is a widely-used additive manufacturing technology. Commonly, photocurable acrylate or methacrylate resin compositions are used to create 3D objects via actinic radiation curing in the illuminated area. Inverse Vat Polymerization is becoming very popular because of the decrease in required photocurable resin and user-friendly nature of digital light processing (DLP) projectors over laser systems. The bottom-up approach, also called Inverse Vat Polymerization, can be implemented by DLP machines, lasers, and liquid crystal display-based light sources, in which the light source (e.g., DLP projector) is placed below the resin vat and projected upwards. It is essential to ensure that the printed objects preferentially stick to the build platform rather than the bottom of the resin vat. This has been achieved in different ways by manufacturers. Generally, a release material or coating has been used on the resin vat side to avoid sticking issues. Fluorinated films and silicone coated films have become the norm in the industry. This, however, can make clean-up an issue for users and tends to decrease the success rate of the printed objects. The problem of adhesion on the build platform becomes more prominent for highly filled resins (composites, ceramic slurries, dispersions), which might be attributed to their lower UV curable content.

It has been discovered that use of certain multilayer articles in additive manufacturing methods can enable more successful formation of objects on a build platform, particularly for Inverse Vat Polymerization methods. Surprisingly, having macro-porosity on the build platform helped consistently get better adhesion between the build platform and part (i.e., cured object). In contrast, merely roughening the surface of the build platform to form micro-porosity was not successful in significantly improving adhesion between the build platform and a cured object.

In a first aspect, a method of making an additive manufactured article is provided. The method includes a) attaching a multilayer structure to a build platform; b) selectively curing a photocurable composition that is in contact with the porous layer of the multilayer structure, thereby forming an object attached to the porous layer; and c) separating the object from the build platform. The multilayer structure includes an adhesive layer, an impermeable layer attached to the adhesive layer, and a porous layer attached to the impermeable layer. The adhesive layer of the multilayer structure is attached to the build platform. Accordingly, the porous layer is the outermost layer when the multilayer structure is attached to the build platform.

In a second aspect, an object is provided. The object is prepared by the method according to the first aspect.

In a third aspect, a multilayer article is provided. The multilayer article includes a) an adhesive layer; b) an impermeable layer attached to the adhesive layer; and c) a porous layer attached to the impermeable layer. The porous layer includes either i) a plurality of fibers or ii) a foam and comprises a plurality of pores having an average diameter of 1 micrometer to 1.5 millimeters.

The below disclosure relates to each of the first through third aspects.

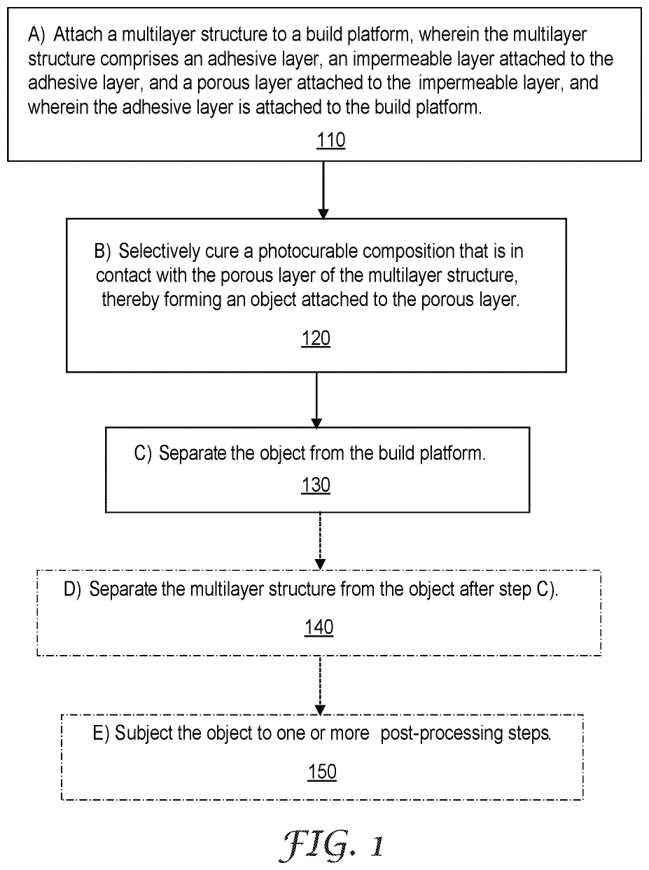

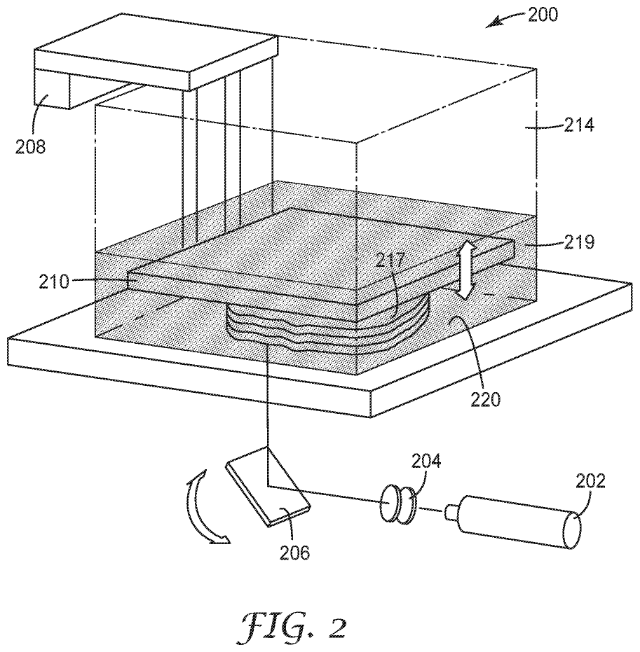

Referring to FIG. 1, a generalized flow chart is provided of a method of making an additive manufactured article. In particular, the method includes the steps of: A) attaching a multilayer structure to a build platform, wherein the multilayer structure comprises an adhesive layer, an impermeable layer attached to the adhesive layer, and a porous layer attached to the impermeable layer, and wherein the adhesive layer is attached to the build platform 110; B) selectively curing a photocurable composition that is in contact with the porous layer of the multilayer structure, thereby forming an object attached to the porous layer 120; and C) separating the object from the build platform 130. Optionally, the method further includes at least one of the steps D) separating the multilayer structure from the object after step C) 140, or E) subjecting the object to one or more post-processing steps 150. For instance, in some embodiments, the method further comprises the step F) of subjecting the article to actinic radiation to photopolymerize uncured photocurable composition. Typically, the photocurable composition is cured using actinic radiation comprising UV radiation, e-beam radiation, visible radiation, or a combination thereof.

In certain embodiments, step A) of attaching the multilayer structure to the build platform comprises applying pressure to the multilayer structure using a roller. Use of the roller can enhance contact and adhesion between the adhesive layer of the multilayer structure and the build platform. In alternate embodiments, it is not necessary to apply force using a tool such as a roller, but rather hand pressure may be sufficient to secure the multilayer structure to the build platform.

In some embodiments, the step B) of selectively curing the photocurable composition that is in contact with the porous layer of the multilayer structure comprises: 1) subjecting a first portion of the photocurable composition to actinic radiation to form a first portion of the object attached to the build platform; 2) moving the build platform; 3) subjecting a second portion of the photocurable composition to actinic radiation to form a second portion of the object, wherein the second portion of the object is attached to the first portion of the object; and 4) optionally repeating steps 2) and 3) a plurality of times. Such a method includes a typical layer by layer additive manufacturing process. Often, step 2) occurs after step 1). Alternatively, in some embodiments, the step 2) of moving the build platform occurs simultaneously with step 3). Such a method includes a “continuous” additive manufacturing process, as defined above.

The object can be separated from the build platform in different ways. For instance, in some embodiments, step C) of separating the object from the build platform comprises separating the multilayer structure from the object. The multilayer structure can be separated from the object, for instance, using a blade to cut off or pry apart the object from the multilayer structure. In such embodiments, often the method further comprises separating the multilayer structure from the build platform. The multilayer structure may be separated from the build platform by peeling the multilayer structure off the build platform, scraping the multilayer structure off the build platform with a tool (e.g., a blade), or a combination thereof. Alternatively, the object can be separated from the build platform by first removing the multilayer structure from the build platform, followed by separating the multilayer structure from the object.

In preferred embodiments, following separation of the multilayer structure from the build platform, a surface of the build platform advantageously has a total surface area, of which 5% or less, 4% or less, 3% or less, 2% or less, or even 1% or less of the total surface area, and 0% or greater, is covered in adhesive from the adhesive layer of the multilayer structure. In embodiments in which the multilayer structure has an area that is smaller than the area of the build platform, the total surface area of the build platform that could be covered in adhesive is the same as the total size of the surface area of the multilayer structure. Having such a low amount of surface area of the build platform covered in adhesive after removal of the multilayer structure from the build platform decreases the amount of effort required to clean the build platform prior to its next use. In certain embodiments according to the present disclosure, the build platform surface can effectively be cleaned by wiping with alcohol to dissolve remaining adhesive residue.

A general schematic is provided of a stereolithography (SLA) apparatus that may be used with photocurable compositions and methods described herein. In general, the apparatus 200 may include a laser 202, optics 204, a steering mirror or lens 206, an elevator 208, and a platform 210, within a vat 214 filled with the photopolymerizable composition 219. In operation, the laser 202 is steered through a wall 220 (e.g., the floor) of the vat 214 and into the photocurable composition to cure a cross-section of the photocurable composition 219 to form an article 217, after which the elevator 208 slightly raises the platform 210 and another cross section is cured. Suitable stereolithography printers include the NextDent 5100 and the FIG. 4, both available from 3D Systems, Rock Hill, SC, and the Asiga PICO PLUS 39, available from Asiga USA, Anaheim Hills, CA.

In a DLP based system, a two-dimensional cross section is projected onto the curable material to cure the desired section of an entire plane transverse to the projected beam at one time.

All such curable polymer systems as may be adapted to use with the photocurable compositions described herein are intended to fall within the scope of the term “vat polymerization system” as used herein.

Suitable photocurable compositions generally include one or more organic thermosetting components (e.g., monomers and oligomers), typically containing one or more additive(s) such as, for example, fillers, curatives (e.g., free-radical initiators (photo- or thermal), antioxidants, and/or light stabilizers).

Multilayer Articles

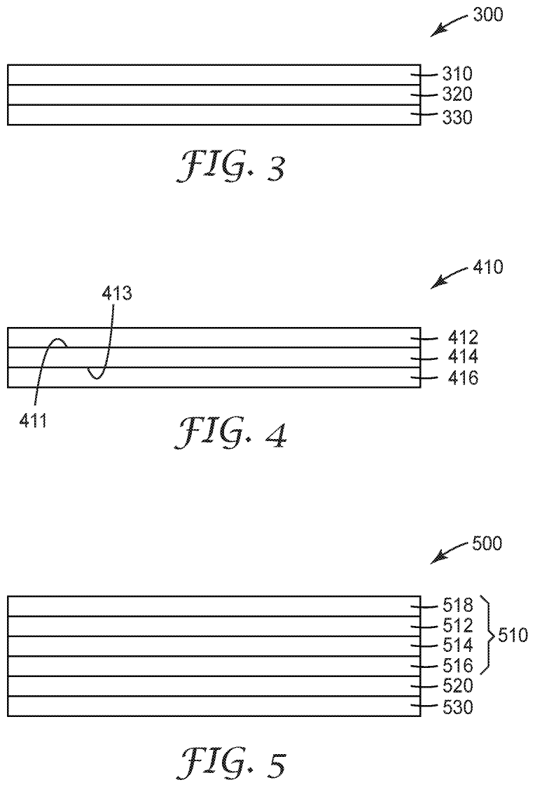

Referring to FIG. 3, a schematic cross-sectional view of an exemplary multilayer article 300 for attachment to the build plate of a bottom-up additive manufacturing apparatus is shown.

The multilayer article 300 comprises: a) an adhesive layer 310; b) an impermeable layer 320 attached to the adhesive layer 310; and c) a porous layer 330 attached to the impermeable layer 320. Accordingly, the impermeable layer 320 is disposed between the adhesive layer 310 and the porous layer 330. The multilayer article preferably has a uniform thickness that varies no more than +/−10% from an average thickness of the multilayer article. A uniform thickness assists in evenly forming an object attached to the porous layer of the multilayer article.

Referring to FIG. 4, in some embodiments of multilayer articles according to the present disclosure, the adhesive layer comprises a multilayer adhesive construction 410. For instance, the multilayer adhesive construction 410 of FIG. 4 comprises a first adhesive composition 412 attached to a major surface 411 of a substrate 414 and a second adhesive composition 416 attached to an opposing major surface 413 of the substrate 414. Typically, at least one of the first adhesive composition 412 and the second adhesive composition 416 is a pressure sensitive adhesive composition. In some embodiments, the first adhesive composition is different from the second adhesive composition. For instance, when one of the first or second adhesives is a pressure sensitive adhesive, the other may be a structural adhesive, a hot melt adhesive, and/or a foam adhesive. In any embodiment of the multilayer article, a release liner may optionally be attached to the adhesive layer, e.g., to protect the adhesive prior to use.

Referring to FIG. 5, a schematic cross-sectional view is provided of an exemplary multilayer article 500. The multilayer article 500 comprises an adhesive layer 510, which is a multilayer construction comprising a first pressure sensitive adhesive layer 512 attached to a substrate (e.g., a carrier film) 514 and a second pressure sensitive adhesive layer 516 attached to the substrate 514. Further, the multilayer construction comprises a release layer 518 attached to the first pressure sensitive adhesive layer 512, which will be removed prior to adhering the first pressure sensitive adhesive layer 512 to a build platform. The second pressure sensitive adhesive layer 516 is attached to an impermeable layer 520. The impermeable layer 520 is attached to a porous layer 530. In some embodiments, the impermeable layer 520 is a polypropylene-polyethylene copolymer film and the porous layer 530 is a polypropylene spunbond nonwoven layer. The polypropylene spunbond layer comprises a plurality of nonwoven fibers (not shown). In some embodiments, the porous layer 530 is a foam layer.

Suitable characteristics and materials for the various layers of multilayer articles according to the present disclosure are described below.

Porous Layer

The porous layer provides a macro-scale porosity for the photocurable composition to adhere to as it is cured to form an additive manufactured object/article. It has been discovered that certain porous layers enable the successful vat polymerization of some photocurable compositions when a bottom-up printing approach is employed.

In some embodiments, suitable structures for the porous layer include a plurality of fibers that exhibits a certain percent solidity. “Solidity” is a nonwoven web property inversely related to density and characteristic of web permeability and porosity (i.e., low solidity corresponds to high permeability and high porosity), and is defined by the following equation:

Solidity percent (%)=(3.937*Web Basis Weight (g/m²))/(Web Thickness (mils)*Bulk Density (g/cm³))

For the above equation, the web basis weight is calculated from the weight of a 10 centimeter (cm) by 10 cm web sample and is usually expressed in grams per square meter (gsm). The web thickness is measured on a 10 cm by 10 cm web sample using a thickness testing gauge having a tester foot with dimensions of 5 cm by 12.5 cm at an applied pressure of 150 Pascals (Pa), where one mil is one thousandth of an inch, or 25.4 micrometers. The bulk density is the mass per unit volume of the bulk polymer or polymer blend that makes up the web, taken from the literature.

The percent solidity characteristic is indicative of the porosity of the porous layer. Having such a porosity allows for photocurable composition to at least partially flow between some of the fibers of the porous layer, which improves adhesion of the object formed to the porous layer as the photocurable composition in contact with the porous layer is cured. If the porous layer has too high a percent solidity, not enough photocurable composition can interact with the fibers of the porous layer to successfully adhere the formed object to the porous layer until the conclusion of the additive manufacturing process. If the porous layer has too low a percent solidity, the fibers of the porous layer will get pulled down into the photocurable composition as the additive manufacturing process continues. Preferably, the fibers of the porous layer stay attached to the porous layer instead of breaking off into the photocurable composition and/or becoming embedded into the formed object during the additive manufacturing process.

In some embodiments, the porous layer comprises a nonwoven substrate or a woven substrate. Optionally, the porous layer comprises a mesh structure. The porous layer often comprises a plurality of fibers bonded together at one or more points, which increases the resistance of the fibers to separating under the gravitational force of a formed object while the build platform rises during the additive manufacturing process.

Suitable structures for the porous layer also include a foam that has a plurality of pores having an average diameter of 1 micrometer to 1.5 millimeters. Average pore diameter (where the local pore diameter is the longest dimension that passes through the center across a pore) can be determined using image analysis of a portion of a foam surface and averaging the diameter of at least 50 individual pores. Similar to percent solidity, the pore size is selected to allow for photocurable composition to at least partially flow into some of the pores of the porous layer, which improves adhesion of the object formed to the porous layer as the photocurable composition in contact with the porous layer is cured. If the porous layer has too small an average pore size, not enough photocurable composition can interact with surfaces of the pores of the porous layer to successfully adhere the formed object to the porous layer until the conclusion of the additive manufacturing process. If the porous layer has too large an average pore size, not enough surface area of the photocurable composition can interact with surfaces of the pores to successfully adhere the formed object to the foam. The foam comprises an open cell foam so that the photocurable composition contacts pores from an exterior major surface of the foam layer. The average diameter of the pores is 1 micrometer or larger, 5 micrometers or larger, 10 micrometers or larger, 20 micrometers or larger, 30 micrometers or larger, 50 micrometers or larger, 75 micrometers or larger, 100 micrometers or larger, 125 micrometers or larger, 175 micrometers or larger, 225 micrometers or larger, 275 micrometers or larger, 325 micrometers or larger, 425 micrometers or larger, or 475 micrometers or larger; and 1.5 millimeters or smaller, 1.4 millimeters or smaller, 1.3 millimeters or smaller, 1.2 millimeters or smaller, 1.1 millimeters or smaller, 1 millimeter or smaller, 950 micrometers or smaller, 900 micrometers or smaller, 850 micrometers or smaller, 800 micrometers or smaller, 750 micrometers or smaller, 700 micrometers or smaller, 650 micrometers or smaller, 600 micrometers or smaller, 550 micrometers or smaller, 500 micrometers or smaller, 450 micrometers or smaller, 400 micrometers or smaller, 350 micrometers or smaller, 300 micrometers or smaller, 250 micrometers or smaller, or 200 micrometers or smaller. In an embodiment, the average diameter of the pores is 20 micrometers to 200 micrometers, inclusive.

The material of which the porous layer is formed is not particularly limited. In some embodiments, the material is compatible with at least one of water, solvent(s), or resin(s) of a photocurable composition. By compatible is meant that a surface of the material will not significantly reduce in physical properties, such as swelling or dissolving, and will be wetted by the water, solvent(s), and/or resin(s) when contacted together during an additive manufacturing process. In some embodiments, the fibers or foam structure of the porous material may exhibit some swelling while in contact with the photocurable composition.

For instance and without limitation, some suitable materials for a porous layer according to the present disclosure include a polyacrylate, a polymethacrylate, a poly(methyl methacrylate), a polysiloxane, a styrene-isoprene block copolymer, a styrene ethylene butylene styrene polymer, a hydrogenated styrene ethylene butadiene styrene polymer, a polyamide-imide, a polyester, a polyphosphoester, a polyethersulfone, a polyetherimide, a polyarylate, a polysulfone, a polyvinylchloride, an acrylonitrile butadiene styrene, a polystyrene, a poly(alpha-methyl styrene), a polyethylene, a polypropylene, a polyolefin, a polyurethane, a fluoroelastomer, a fluoropolymer, a polyamide, a polyacetal, a polyanhydride, a polycarbonate, a polyether, a poly(ether ketone), a poly(phenylene oxide), a poly(vinyl ester), a poly(vinyl ether), a poly(vinyl ketone), a poly(vinyl thioether), and copolymers thereof, metals (e.g., copper, aluminum, steel, nickel, or silver), or combinations thereof. In some embodiments, the porous layer comprises a polypropylene.

Impermeable Layer

The impermeable layer acts as a barrier between the porous layer and the adhesive layer. More particularly, the impermeable layer minimizes contact between the adhesive layer and components of a photocurable composition that may decrease the adhesion of the adhesive layer to the build platform of an additive manufacturing apparatus. The mechanism for lowered adhesion may vary, depending on the composition of the adhesive material and the composition of the photocurable composition. In certain embodiments, the adhesive can become degraded, dissolved, and/or swollen upon contact with a photocurable composition, leading to failure of a multilayer article due to delamination between at least two layers of the multilayer article.

As noted above, it is not necessary for the impermeable layer to minimize or prevent passing of a fluid under all conditions to meet the definition of being “impermeable”. Rather, the impermeable layer needs to be sufficiently impermeable to the contents of a photocurable composition with which it is in contact for the duration of an additive manufacturing process to maintain the adhesion of the adhesive layer of the multilayer article to the build platform. Often, the impermeable layer is impermeable to each of water and organic solvents (e.g., alcohols) when contacted with the water or organic solvent for 1 hour under a pressure of 30 psi (200 kilopascals) or less. In some embodiments, the layer is compatible with one or more components of a photocurable composition such that a surface of the impermeable layer will be wetted by the water, solvent(s), and/or resin(s) when contacted. Preferably, the impermeable layer does not swell when contacted with a photocurable composition.

In select embodiments, the impermeable layer is nonporous. By “nonporous” is meant that the impermeable layer comprises a continuous film of material (e.g., lacking through pores).

In some embodiments, the impermeable layer need not be a continuous material, but may still meet the criteria of being impermeable. For instance, a suitable impermeable material may comprise a melt-blown substrate. A melt-blown substrate is formed of “melt-blown fibers”, which are fibers prepared by a melt-blowing or melt blown process. The term is used in general to designate discontinuous fibers formed from one or more molten stream(s) of one or more thermoplastic (co)polymer(s) that are extruded from one or more orifice(s) of a melt-blowing die and subsequently cooled to form solidified fibers and webs comprised thereof. A die is a processing assembly including at least one orifice for use in polymer melt processing and fiber extrusion processes, including but not limited to melt-blowing. “Melt-blowing” and a “melt blown process” refer to a method for forming a nonwoven fibrous web by extruding a molten fiber-forming material comprising one or more thermoplastic (co)polymer(s) through at least one or a plurality of orifices to form filaments while contacting the filaments with air or other attenuating fluid to attenuate the filaments into discrete fibers, and thereafter collecting the attenuated fibers. An exemplary melt-blowing process is taught in, for example, U.S. Pat. No. 6,607,624 (Berrigan et al.).

In many embodiments, the porous layer is directly bonded to the impermeable layer. Such an attachment eliminates the need for an adhesive to bind the porous layer to the impermeable layer, as such an adhesive may also be impacted by contact with one or more components of a photocurable composition, potentially delaminating the porous layer from the impermeable layer. In embodiments in which the porous layer is indirectly bonded to the impermeable layer, a structural adhesive may preferably be used, due to its greater resistance to chemicals than most other adhesives. In embodiments in which the porous layer and the impermeable layer are directly bonded, preferably the material of each of the porous layer and the impermeable layer is selected to have compatibility with each other, for greater bond strength. The same polymeric materials are suitable for the impermeable layer as described above with respect to the porous layer.

Adhesive Layer

The adhesive layer acts to securely attach the multilayer article to a build platform of an additive manufacturing apparatus (e.g., a vat polymerization printer). Preferably, the adhesive layer provides not only sufficient adhesion of the multilayer article for a successful article build but also easy removal of the multilayer article from the build platform following completion of the article formation.

Suitable adhesives for use in the adhesive layer include for instance and without limitation, a pressure sensitive adhesive (e.g., an acrylic PSA), a structural adhesive, a hot melt adhesive, and/or a foam adhesive. An acrylic adhesive includes an acrylic ester type pressure sensitive adhesive. A hot melt adhesive refers to an adhesive such as polyolefin block copolymers (SBS, SIS), ethylene-vinyl acetate copolymer (EVA) or the like, which is a solid at room temperature and can achieve adhesion in several minutes of pressing and cooling after being melted into a liquid by heating and coated on an article to be adhered. A structural adhesive includes an adhesive of epoxy resin, polyurethane or the like, which has high strength, relatively large loading endurance, aging resistance, fatigue resistance, corrosion resistance, stable performance in predetermined life, and are applicable to the adhesion of the structures for bearing strong force. A foam adhesive includes an adhesive which provides an adhesive layer with bonding performance on one side or both sides of the foam or foaming material by using the above foam or foaming material as a substrate, so as to form a composite adhering material with compressibility and specific bonding performance.

In some embodiments, the adhesive layer of the multilayer article is formed of a single adhesive, such as a pressure sensitive adhesive (PSA) composition. Using a PSA as the adhesive tends to advantageously allow for secure attachment of the multilayer article to the build platform followed by ready removal of the multilayer article from the build platform surface after use.

In some embodiments, the adhesive layer comprises a multilayer adhesive construction, which allows the use of two different adhesives that have different performance, as discussed above with respect to FIG. 4. When a multilayer adhesive construction has two different pressure sensitive adhesives disposed on either side of a substrate, in which a first adhesive exhibits a higher tack than a second adhesive, typically the multilayer adhesive construction is employed such that the first adhesive is attached to the impermeable layer of the multilayer article and the second adhesive is attached to the build platform. This is because the second adhesive, having lower tack, will be removed from the build platform following use, and the first adhesive, having higher tack, does not need to be removed from either the impermeable layer or the substrate.

Additive Manufacturing

Data representing an article may be generated using computer modeling, such as computer aided design (CAD) data. Image data representing the article design can be exported in STL format, or in any other suitable computer processable format, to the additive manufacturing equipment. Scanning methods to scan a three-dimensional object may also be employed to create the data representing the article. One exemplary technique for acquiring the data is digital scanning Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al.). The initial digital data set, which may include both raw data from scanning operations and data representing articles derived from the raw data, can be processed to segment an article design from any surrounding structures (e.g., a support for the article).

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to a computer, such as another networked computer. A computing device often includes an internal processor, a display (e.g., a monitor), and one or more input devices such as a keyboard and a mouse.

Referring to FIG. 6, in certain embodiments, the present disclosure provides a system 600. The system 600 comprises a display 620 that displays a 3D model 610 of an article; and one or more processors 630 that, in response to the 3D model 610 selected by a user, cause a 3D printer/additive manufacturing device 650 comprising an exemplary multilayer article to create a physical object of the article 660. Often, an input device 640 (e.g., keyboard and/or mouse) is employed with the display 620 and the at least one processor 630, particularly for the user to select the 3D model 610.

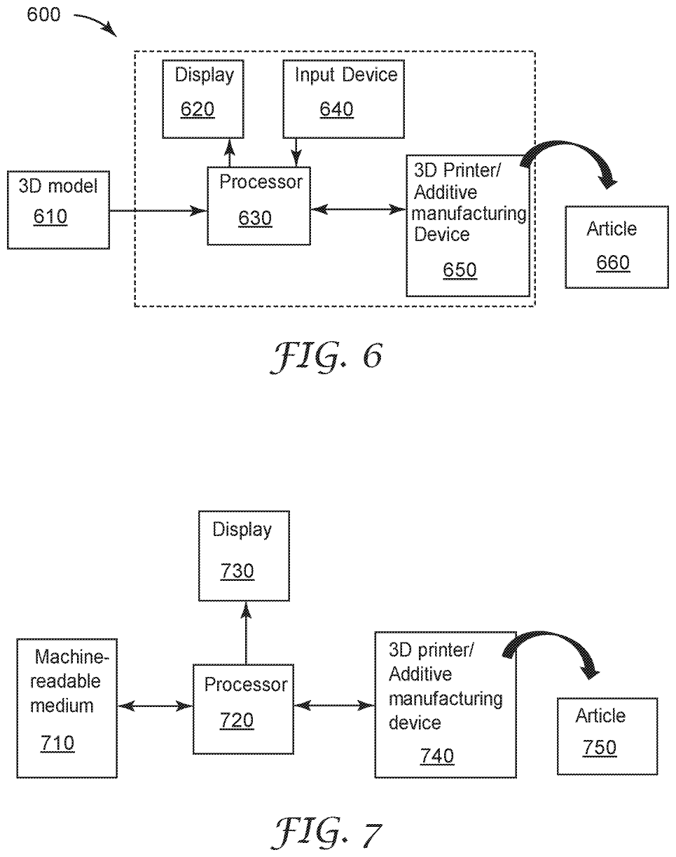

Referring to FIG. 7, a processor 720 (or more than one processor) is in communication with each of a machine-readable medium 710 (e.g., a non-transitory medium), a 3D printer/additive manufacturing device 740, and optionally a display 730 for viewing by a user. The 3D printer/additive manufacturing device 740 comprises an exemplary multilayer article and is configured to make one or more articles 750 based on instructions from the processor 720 providing data representing a 3D model of the article 750 from the machine-readable medium 710.

Methods of printing a three-dimensional article or object described herein can include forming the article from a plurality of layers of a photocurable composition described herein in a layer-by-layer manner. Further, the layers of a build material composition can be deposited according to an image of the three-dimensional article in a computer readable format. In some or all embodiments, the photocurable composition is deposited according to preselected computer aided design (CAD) parameters (e.g., a data file).

For example, in some cases, a method of printing a 3D article comprises retaining a photocurable composition described herein in a fluid state in a container and selectively applying energy to the photocurable composition in the container to solidify at least a portion of a fluid layer of the photocurable composition, thereby forming a hardened layer that defines a cross-section of the 3D article. Additionally, a method described herein further comprises raising the hardened layer of photocurable composition to provide a new or second fluid layer of unhardened photocurable composition at the surface of the fluid in the container, followed by again selectively applying energy to the photocurable composition in the container to solidify at least a portion of the new or second fluid layer of the photocurable composition to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the photocurable composition. Moreover, selectively applying energy to the photocurable composition in the container can comprise applying actinic radiation, such as UV radiation, visible radiation, or e-beam radiation, having a sufficient energy to cure the photocurable composition. A method described herein can also comprise planarizing a new layer of fluid photocurable composition provided by raising or lowering an elevator platform. Such planarization can be carried out, in some cases, by utilizing a wiper or roller or a recoater. Planarization corrects the thickness of one or more layers prior to curing the material by evening the dispensed material to remove excess material and create a uniformly smooth exposed or flat up-facing surface on the support platform of the printer.

It is further to be understood that the foregoing process can be repeated a selected number of times to provide the 3D article. For example, in some cases, this process can be repeated “n” number of times. Further, it is to be understood that one or more steps of a method described herein, such as a step of selectively applying energy to a layer of photocurable composition, can be carried out according to an image of the 3D article in a computer-readable format.

Other techniques for three-dimensional manufacturing are known and may be suitably adapted to use in the applications described herein. More generally, three-dimensional fabrication techniques continue to become available. All such techniques may be adapted to use with photocurable compositions described herein, provided they offer compatible fabrication viscosities and resolutions for the specified article properties, for instance, continuous additive manufacturing in which a build plate is (essentially) continuously moved through a vat of photocurable material. In certain embodiments, an apparatus adapted to be used in a continuous mode may be employed, such as an apparatus commercially available from Carbon 3D, Inc. (Redwood City, Calif.), for instance as described in U.S. Pat. Nos. 9,205,601 and 9,360,757 (both to DeSimone et al.). Fabrication may be performed using any of the fabrication technologies described herein, either alone or in various combinations, using data representing a three-dimensional object, which may be reformatted or otherwise adapted as necessary for a particular printing or other fabrication technology.

After an article has been formed, it is typically removed from the additive manufacturing apparatus, and at least some composition containing uncured photocurable material is removed from the surface of the article, such as by using mass inertial force or washing, as described above. At this stage, the three-dimensional article typically has sufficient green strength for handling in any remaining steps of the method. The article surface, as well as the bulk article itself, typically still retain uncured material, suggesting a need for further curing. Removing residual uncured photocurable composition is particularly useful when the article is going to subsequently be post-cured, to minimize uncured residual material from undesirably curing directly onto the article. A “cured” article can comprise at least one photocurable component (e.g., monomer, oligomer, polymer, etc.) that has been at least partially polymerized and/or crosslinked. For instance, in some instances, an at least partially polymerized article is at least about 10% polymerized or crosslinked or at least about 30% polymerized or crosslinked. In some cases, an at least partially polymerized article is at least about 50%, at least about 70%, at least about 80%, or at least about 90% polymerized or crosslinked, for instance between about 10% and about 99% polymerized or crosslinked. Some components may not be reacted at all during this (initial) curing stage.

Further curing can be accomplished by further irradiating with actinic radiation, heating, or both. Exposure to actinic radiation can be accomplished with any convenient radiation source, generally UV radiation, visible radiation, and/or e-beam radiation, for a dose of at least 1 Joules per square centimeter (J/cm²), or equivalent. Heating is generally carried out at a temperature in the range of about 35-120° C., for a duration of at least 10 minutes and optionally in an inert atmosphere. So called post-cure ovens, which combine UV radiation and thermal energy, are particularly well suited for use in the post-cure process(es). In general, post curing improves the mechanical properties and stability of the three-dimensional article relative to the same three-dimensional article that is not post cured.

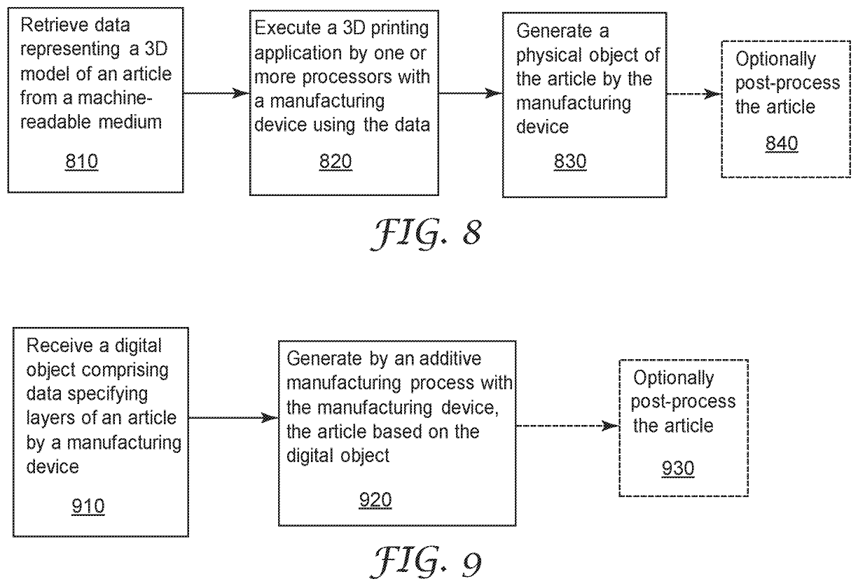

Referring to FIG. 8, for example and without limitation, an additive manufacturing method comprises retrieving 810, from a (e.g., non-transitory) machine-readable medium, data representing a 3D model of an article according to at least one embodiment of the present disclosure. The method further includes executing 820, by one or more processors, an additive manufacturing application interfacing with a manufacturing device using the data; and generating 830, by the manufacturing device comprising an exemplary multilayer article, a physical object of the article. One or more various optional post-processing steps 840 may be undertaken. Typically, uncured photocurable composition is removed from the article, plus the article may further be heat treated and/or sintered.

Additionally, referring to FIG. 9, a method of making an article comprises receiving 910, by a manufacturing device having one or more processors and comprising an exemplary multilayer article, a digital object comprising data specifying an article; and generating 920, with the manufacturing device by an additive manufacturing process, the article based on the digital object. Again, the article may undergo one or more steps of post-processing 930.

Various embodiments are provided that include methods of making additive manufactured articles, objects prepared by the methods, and multilayer articles.

In a first embodiment, the present disclosure provides a method of making an additive manufactured article. The method includes: a) attaching a multilayer structure to a build platform; b) selectively curing a photocurable composition that is in contact with the porous layer of the multilayer structure, thereby forming an object attached to the porous layer; and c) separating the object from the build platform. The multilayer structure comprises an adhesive layer, an impermeable layer attached to the adhesive layer, and a porous layer attached to the impermeable layer. The adhesive layer of the multilayer structure is attached to the build platform.

In a second embodiment, the present disclosure provides a method according to the first embodiment, wherein the selectively curing includes: 1) subjecting a first portion of the photocurable composition to actinic radiation to form a first portion of the object attached to the build platform; 2) moving the build platform; 3) subjecting a second portion of the photocurable composition to actinic radiation to form a second portion of the object, wherein the second portion of the object is attached to the first portion of the object; and 4) optionally repeating steps 2) and 3) a plurality of times.

In a third embodiment, the present disclosure provides a method according to the second embodiment, wherein step 2) occurs after step 1).

In a fourth embodiment, the present disclosure provides a method according to the second embodiment or the third embodiment, wherein the moving of the build platform occurs simultaneously with step 3).

In a fifth embodiment, the present disclosure provides a method according to any of the first through fourth embodiments, wherein step c) comprises separating the multilayer structure from the object.

In a sixth embodiment, the present disclosure provides a method according to the fifth embodiment, further comprising separating the multilayer structure from the build platform.

In a seventh embodiment, the present disclosure provides a method according to any of the first through fourth embodiments, further comprising d) separating the multilayer structure from the object after step c).

In an eighth embodiment, the present disclosure provides a method according to the sixth embodiment or the seventh embodiment, wherein, following separation of the multilayer structure from the build platform, a surface of the build platform has a total surface area of which 5% or less is covered in adhesive from the adhesive layer of the multilayer structure.

In a ninth embodiment, the present disclosure provides a method according to any of the first through eighth embodiments, further comprising cleaning the build platform after step c).

In a tenth embodiment, the present disclosure provides a method according to any of the first through ninth embodiments, wherein step a) comprises applying pressure to the multilayer structure using a roller.

In a eleventh embodiment, the present disclosure provides a method according to any of the first through tenth embodiments, further comprising e) subjecting the object to one or more post-processing steps.

In a twelfth embodiment, the present disclosure provides a method according to any of the first through eleventh embodiments, wherein the porous layer comprises a foam comprising a plurality of pores having an average diameter of 1 micrometer to 1.5 millimeters.

In a thirteenth embodiment, the present disclosure provides a method according to any of the first through eleventh embodiments, wherein the porous layer comprises a plurality of fibers.

In a fourteenth embodiment, the present disclosure provides a method according to any of the first through eleventh embodiments or the thirteenth embodiment, wherein the porous layer comprises a nonwoven substrate.

In a fifteenth embodiment, the present disclosure provides a method according to any of the first through fourteenth embodiments, wherein the impermeable layer is nonporous.

In a sixteenth embodiment, the present disclosure provides a method according to any of the first through fourteenth embodiments, wherein the impermeable layer comprises a melt-blown substrate.

In a seventeenth embodiment, the present disclosure provides a method according to any of the first through sixteenth embodiments, wherein the adhesive layer comprises a multilayer adhesive construction.

In an eighteenth embodiment, the present disclosure provides an object. The object is prepared by a method according to any of the first through seventeenth embodiments.

In a nineteenth embodiment, the present disclosure provides a multilayer article. The multilayer article includes: a) an adhesive layer; b) an impermeable layer attached to the adhesive layer; and c) a porous layer attached to the impermeable layer. The porous layer includes either i) a plurality of fibers or ii) a foam and comprises a plurality of pores having an average diameter of 1 micrometer to 1.5 millimeters.

In a twentieth embodiment, the present disclosure provides a multilayer article according to the nineteenth embodiment, wherein the porous layer comprises a nonwoven substrate or a woven substrate.

In a twenty-first embodiment, the present disclosure provides a multilayer article according to the twentieth embodiment, wherein the porous layer comprises a plurality of fibers bonded together.

In a twenty-second embodiment, the present disclosure provides a multilayer article according to any of the nineteenth through twenty-first embodiments, wherein the multilayer article has a uniform thickness that varies no more than +/−10% from an average thickness of the multilayer article.

In a twenty-third embodiment, the present disclosure provides a multilayer article according to any of the nineteenth through twenty-second embodiments, wherein the porous layer is directly bonded to the impermeable layer.

In a twenty-fourth embodiment, the present disclosure provides a multilayer article according to any of the nineteenth through twenty-third embodiments, wherein the impermeable layer is impermeable to water and organic solvents when contacted with the water or organic solvent for up to 1 hour under a pressure of 30 psi (200 kilopascals) or less.

In a twenty-fifth embodiment, the present disclosure provides a multilayer article according to any of the nineteenth through twenty-fourth embodiments, wherein the impermeable layer is impermeable to water and alcohols when contacted with the water or alcohols for up to 1 hour under a pressure of 30 psi (200 kilopascals) or less.

In a twenty-sixth embodiment, the present disclosure provides a multilayer article according to any of the nineteenth through twenty-fifth embodiments, wherein the adhesive layer is formed of a single pressure sensitive adhesive composition.

In a twenty-seventh embodiment, the present disclosure provides a multilayer article according to any of the nineteenth through twenty-fifth embodiments, wherein the adhesive layer comprises a multilayer adhesive construction.

In a twenty-eighth embodiment, the present disclosure provides a multilayer article according to the twenty-seventh embodiment, wherein the multilayer adhesive construction comprises a first adhesive composition attached to a major surface of a substrate and a second adhesive composition attached to an opposing major surface of the substrate, wherein at least one of the first adhesive composition and the second adhesive composition is a pressure sensitive adhesive composition.

In a twenty-ninth embodiment, the present disclosure provides a multilayer article according to the twenty-eighth embodiment, wherein the first adhesive composition is different from the second adhesive composition.

In a thirtieth embodiment, the present disclosure provides a multilayer article according to any of the fourteenth through twenty-ninth embodiments, further comprising a release liner attached to the adhesive layer.

### EXAMPLES

Unless otherwise noted or apparent from the context, all parts, percentages, ratios, etc. in the Examples and the rest of the specification are by weight.

### Example 1

A silicon nitride-containing resin was printed on an Asiga Pico 2 HD (Asiga, Sydney, Australia), modified to use a 460 nm LED light source. The print was run with 10 micrometer layers at 10 seconds of cure per layer, at the full printer intensity. The components of the resin are provided in Table 1 below. The build platform was covered with a piece of 3M Self-Stick Liquid Protection Fabric (SSLPF) (3M Company, St. Paul, Minn.), such that >1 centimeter of excess material extended over all sides of the build platform. The excess material was folded up and attached to the sides of the build platform block. The SSLPF is an adhesive-backed surface protection material including a polymer layer and a nonwoven surface.

TABLE 1
Components of Silicon Nitride-Containing Resin in Ex. 1

| Material | Source | Wt. % |
|---|---|---|
| Sartomer SR399 | Sartomer (Exton, | 12.6 |
| (Dipentaerythritol | PA, USA) | |
| Pentaacrylate) | | |
| Sartomer SR351LV | Sartomer | 7.1 |
| (Trimethylolpropane | | |
| triacrylate) | | |
| Sartomer SR506C | Sartomer | 5.0 |
| (Isobornyl acrylate) | | |
| SN E-10 Si₃N₄ powder | UBE Industries | 29.7 |
| mixed with sintering aids | (Tokyo, Japan) | |
| Carbitol solvent | Dow Chemical | 44.6 |
| (Diethylene Glycol | (Midland, MI, USA) | |
| Monoethyl Ether) | | |
| CPQ-based 3 part | Sigma Aldrich (St. | 0.84 |
| photoinitiator system | Louis, MO, USA) | |
| (Camphorquinone, Ethyl-4- | | |
| dimethylamino benzoate, and | | |
| Diphenyliodonium | | |
| hexafluorophosphate) | | |
| BHT inhibitor (Butylated | Fluka Analytical | 0.10 |
| hydroxytoluene) | (St. Louis, MO, USA) | |

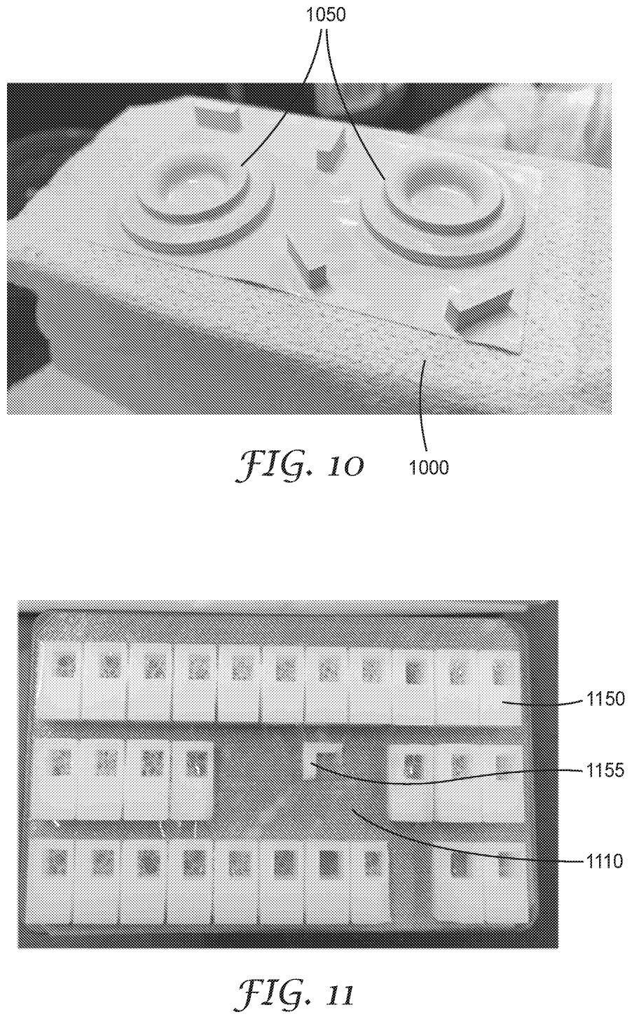

This particular resin has been difficult to print due to poor adhesion to typical flat metal build platforms. Using the multilayer SSLPF article improved adhesion to the build platform, facilitating a full print without early delamination or separation. Referring to FIG. 10, a photograph is provided of two exemplary additive manufactured (e.g., printed) articles, prepared according to Example 1. The articles 1050 are still attached to the multilayer article 1000 on the build platform.

### Nonwoven Multilayer Articles

TABLE 2
Components of PTFE-Containing Resin

| Material | Source | Wt. % |
|---|---|---|
| Sartomer SR415 (Ethoxylated | Sartomer (Exton, | 8.74 |
| trimethylolpropane triacrylate) | PA, USA) | |
| Sartomer SR344 (Polyethylene | Sartomer | 8.74 |
| glycol (400) diacrylate) | | |
| Deionized Water | | 12.23 |
| 3M DYNEON PTFE Dispersion TF | 3M Company (St. | 69.89 |
| 5135GZ | Paul, MN, USA) | |
| OMNIRAD TPO-L | IGM Resins (Waalwijk, | 0.25 |
| | the Netherlands) | |
| BHT inhibitor (Butylated | Sigma Aldrich (St. | 0.10 |
| hydroxytoluene) | Louis, MO, USA) | |
| Benetex Ob-M1 | Benetex (Suwanee, | 0.05 |
| | GA, USA) | |

### Process for Comparative Examples 1-2 and Examples 2-3

A PTFE-containing resin was printed on an Asiga MAX UV (Asiga, Sydney, Australia), equipped with a 385 nm LED light source. The components of the resin are provided in Table 2 above. The PTFE-containing resin is difficult to print due to poor adhesion to traditional flat metal build platforms. The print was run with 50 micrometer layers at 3 seconds of cure per layer, at the full printer intensity (approximately 9.5 mW/cm²), with 7.5 seconds of burn-in exposure for the first 3 layers. The build platform was covered with the respective nonwoven materials detailed in each example below, attached to the build platform using 3M 9425HT double-sided tape (3M Company, MN, USA). The 9425HT tape includes high-tack, permanent adhesive on one side and medium-tack adhesive on the other, with a polyethylene terephthalate (PET) carrier in between the two adhesives.

### Comparative Example 1

The nonwoven material used was a thin white nonwoven from Huhtamaki Films Spunbond & Embossed identified as low density polyethylene (LDPE) with polypropylene (PP)/LDPE film—24 grams per square meter (gsm) PP, 12 gsm nonwoven, and 12 gsm LDPE. Referring to FIG. 11, a photograph is provided showing that use of the nonwoven material 1110 of Comparative Example 1 exhibited multiple failed cured articles of PTFE-containing resin (e.g., partially printed article 1155) in its center region and thus did not provide sufficient improvement in adhesion despite also successfully printing numerous articles 1150.

### Comparative Example 2

The nonwoven material used was a fibrous blue nonwoven (Midwest Supplies, Sauget, IL) identified as Unipro 275 PP SMS (Spunbond-Meltblown-Spunbond). The nonwoven material of Comparative Example 2 exhibited multiple failed cured articles of PTFE-containing resin in its center region and thus did not provide sufficient improvement in adhesion.

### Example 2

The nonwoven material used was a light blue nonwoven in a spunbond-meltblown-spunbond type construction with a lighter than typical meltblown layer. The nonwoven material of Example 2 exhibited adhered cured articles of PTFE-containing resin, had no failed articles, and was thus a suitable nonwoven material for platform adhesion promotion.

### Example 3

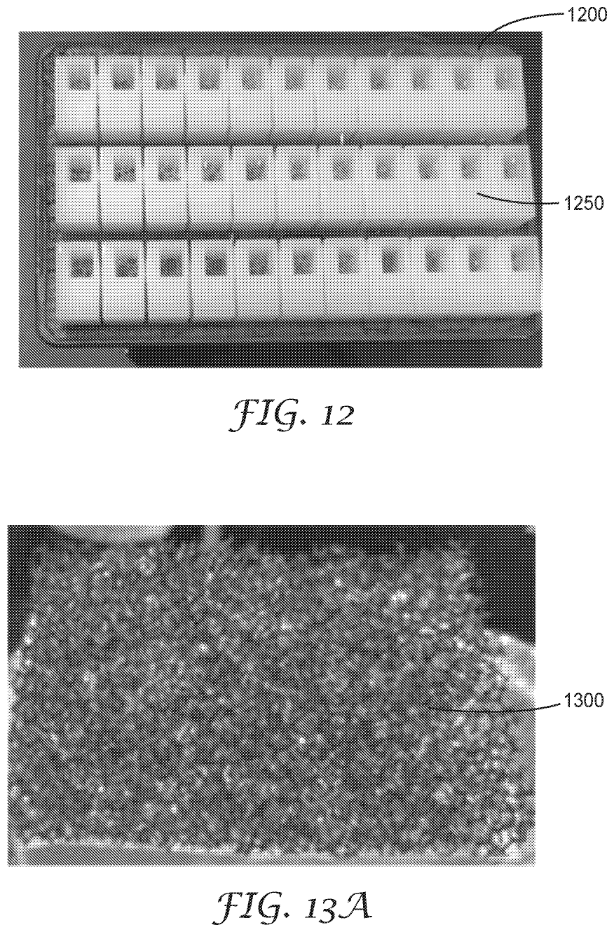

The nonwoven material used was 3M EBL diaper tape (3M Securon Film, 3M Fairmont, MN, USA). The nonwoven material of Example 3 exhibited adhered cured articles of PTFE-containing resin, had no failed articles, and was thus a suitable nonwoven for platform adhesion promotion. Referring to FIG. 12, a photograph is provided of the printed articles, prepared according to Example 3. The articles 1250 are still attached to the multilayer article 1200.

### Foam Multilayer Articles

### Process for Comparative Examples 3-6 and Examples 4-7

The PTFE-containing resin was printed on an Asiga Pico 2 HD UV (Asiga, Sydney, Australia), equipped with a 385 nm LED light source. The components of the resin are provided in Table 2 above. The PTFE-containing resin is difficult to print due to low adhesion to traditional flat metal build platforms. The print was run with 50 micrometer layers at 0.9 seconds of cure per layer, at the full printer intensity (approximately 24.7 mW/cm²), with 2 seconds of burn-in exposure for the first 3 layers. The build platform was covered with the respective foam sample detailed in each example below. Each foam was attached to a sheet of nonwoven material (EBL, 3M Company) using 3M SCOTCH-WELD Epoxy Adhesive DP190 (3M Company). The EBL nonwoven material was previously laminated with 3M 9425HT double-sided tape (3M Company), similar to Example 3. The double-side tape provided adhesion of the multilayer article to the build platform while the epoxy adhesive ensured solid and irreversible attachment of the foam sample to the nonwoven material.

### Comparative Example 3

The foam material used was Rogers foam sample 2B, which is an open cell foam with large pores, identified as 1.8#44 IFD Yellow (Rogers Foam Corporation, MA, USA). It provided limited adhesion for the cured articles of PTFE-containing resin, and thus did not provide sufficient improvement in adhesion.

### Comparative Example 4

The foam material used was Rogers foam sample 7A, which is a polyurethane memory foam, identified as low compressive strength (Yellow) (Rogers Foam Corporation, MA, USA). It provided limited adhesion for the cured articles of PTFE-containing resin, and thus did not provide sufficient improvement in adhesion.

### Comparative Example 5

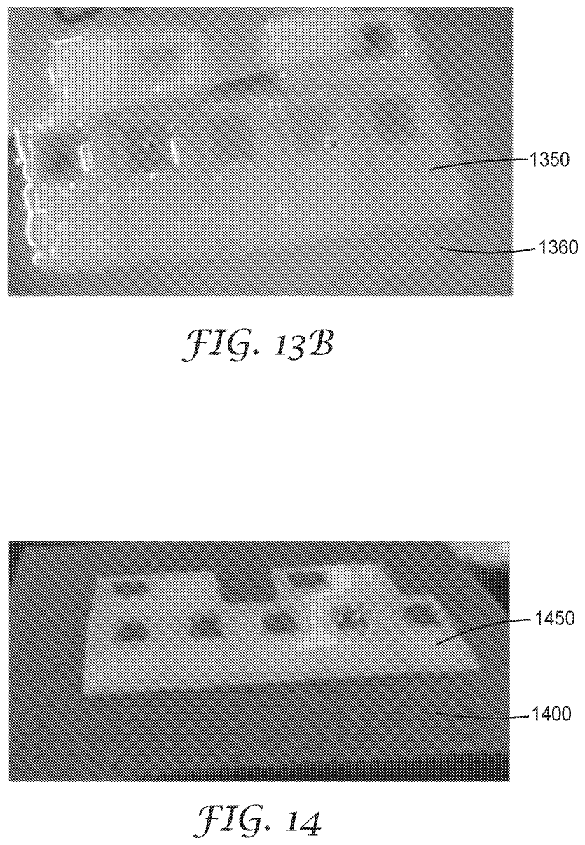

The foam material used was Rogers foam sample 26A, which is a “zapped” large open pore foam, identified as 10PPI thermally reticulated (zapped) (Rogers Foam Corporation, MA, USA). Referring to FIG. 13A, a photograph is provided showing that no articles were successfully adhered to the surface of the foam 1300. FIG. 13B is a photograph showing the cured articles of PTFE-containing resin 1350 stuck on the bottom of the resin container 1360. Thus, the foam material of Comparative Example 5 is not a suitable material for improving adhesion.

### Comparative Example 6

The foam material used was 3M SCOTCH-BRITE Heavy Duty (3M Company). The foam material of Comparative Example 6 provided no adhesion whatsoever for cured articles of PTFE-containing resin and is thus not a suitable material for improving adhesion.

### Example 4

The foam material used was Rogers foam sample 2A, which is an open cell foam with small pores, identified as 1.2#36 IFD Yellow (Rogers Foam Corporation). The foam material of Example 4 provided good adhesion for the cured articles of PTFE-containing resin, and thus is suitable for improving adhesion.

### Example 5

The foam material used was Rogers foam sample 7B, which is a polyurethane memory foam, identified as high compressive strength (Blue) (Rogers Foam Corporation). The foam material of Example 5 provided good adhesion for the cured articles of PTFE-containing resin, and thus is suitable for improving adhesion.

### Example 6

The foam material used was Rogers foam sample 26B, which is a “zapped” open cell foam with small pores, identified as 80PPI thermally reticulated (zapped) (Rogers Foam Corporation). Referring to FIG. 14, a photograph is provided of the printed articles, prepared according to Example 6. The articles 1450 are still attached to the multilayer article 1400. The foam material of Example 6 provided good adhesion for the cured articles of PTFE-containing resin, and thus is suitable for improving adhesion.

### Example 7

The foam material used was 3M SCOTCH-BRITE Light (3M Company). The foam material of Example 7 provided good adhesion for the cured articles of PTFE-containing resin, and thus is suitable for improving adhesion.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A method of making an additive manufactured article, the method comprising:
a) attaching a multilayer structure to a build platform, wherein the multilayer structure comprises an adhesive layer, an impermeable layer attached to the adhesive layer, and a porous layer attached to the impermeable layer, wherein the porous layer comprises either 1) a plurality of fibers or 2) a foam comprising a plurality of pores having an average diameter of 1 micrometer to 1 millimeter, and wherein the adhesive layer is attached to the build platform;
b) selectively curing a photocurable composition that is in contact with the porous layer of the multilayer structure, thereby forming an object attached to the porous layer; and
c) separating the object from the build platform.

2. The method of claim 1, wherein the selectively curing comprises: 1) subjecting a first portion of the photocurable composition to actinic radiation to form a first portion of the object attached to the build platform; 2) moving the build platform; 3) subjecting a second portion of the photocurable composition to actinic radiation to form a second portion of the object, wherein the second portion of the object is attached to the first portion of the object; and 4) optionally repeating steps 2) and 3) a plurality of times.

3. The method of claim 2, wherein step 2) occurs after step 1).

4. The method of claim 2, wherein the moving of the build platform occurs simultaneously with step 3).

5. The method of claim 1, wherein step c) comprises separating the multilayer structure from the object.

6. The method of claim 5, further comprising separating the multilayer structure from the build platform.

7. The method of claim 1, wherein step a) comprises applying pressure to the multilayer structure using a roller.

8. The method of claim 1, wherein the porous layer comprises a foam comprising a plurality of pores having an average diameter of 20 micrometers to 200 micrometers, inclusive.

9. The method of claim 1, wherein the porous layer comprises a nonwoven substrate.

10. The method of claim 1, wherein the adhesive layer comprises a multilayer adhesive construction.

11. An object prepared by the method of claim 1.

12. A multilayer article comprising:
a) an adhesive layer;
b) an impermeable layer attached to the adhesive layer; and
c) a porous layer attached to the impermeable layer, wherein the porous layer comprises either i) a plurality of fibers or ii) a foam and comprises a plurality of pores having an average diameter of 1 micrometer to 1 millimeter.

13. The multilayer article of claim 12, wherein the porous layer comprises a nonwoven substrate or a woven substrate.

14. The multilayer article of claim 13, wherein the porous layer comprises a plurality of fibers bonded together.

15. The multilayer article of claim 12, wherein the multilayer article has a uniform thickness that varies no more than +/−10% from an average thickness of the multilayer article.

16. The multilayer article of claim 12, wherein the adhesive layer comprises a multilayer adhesive construction comprising a first adhesive composition attached to a major surface of a substrate and a second adhesive composition attached to an opposing major surface of the substrate, wherein at least one of the first adhesive composition and the second adhesive composition is a pressure sensitive adhesive composition.

17. The multilayer article of claim 16, wherein the first adhesive composition is different from the second adhesive composition.
